(19) United States
(12) Patent Application Publication
(10) Pub. No.: US 2012/0010994 A1
(43) Pub. Date: Jan. 12, 2012

(54) SYSTEMS AND METHODS FOR TRANSACTION ACCOUNT OFFERINGS

(75) Inventors: Clinton Allen, Chandler, AZ (US); Michael DiGregorio, Mesa, AZ (US); Glade Erikson, Glendale, AZ (US); Deepinder Gulati, Jersey City, NJ (US); Jacob Plammoottil Jacob, Haryana (IN); Sanjiv Khosla, New York, NY (US); Seema Shreshtha, Jersey City, NJ (US)

(73) Assignee: American Express Travel Related Services Company, Inc., New York, NY (US)

(21) Appl. No.: 12/832,240

(22) Filed: Jul. 8, 2010

(51) Int. Cl. G06Q 30/00; G06Q 40/00

(52) U.S. Cl. 705/14.49

(57) ABSTRACT

A method for receiving a user input for providing offerings is disclosed. Fields may be populated for creating a database query for matching a selection of offerings to a population of customers. Data may be received from the database, in response to interactively building the query and/or executing the query. Multiple rank ordered results may be produced for comparison, wherein the producing uses preprogrammed analytics, data from the database and user input, and wherein the results include customer lists linked to a distinct offering and a preferred delivery channel of the offering to a customer. A transaction account may be offered through the preferred delivery channel from the rank ordered transaction account results to the customer. The response from the customer to the offering may be tracked, wherein the preprogrammed analytics are adjusted for use in subsequent offerings based upon the response tracking results.

### FIELD OF THE INVENTION

The present invention generally relates to transaction account offerings, and more particularly, to an integrated system that intelligently targets customers for transaction account offerings.

### BACKGROUND OF THE INVENTION

Financial organizations (e.g., transaction account issuers) often market various products (e.g., transaction accounts) and services to potential customers. Each product/service offered by transaction account issuers typically has specific features that are included to target a specific pool of customers. Further, the targeted pool of customers usually has a specific financial or lifestyle attributes associated with them. For example, if a customer is a frequent-flier, then the transaction account issuers may market a transaction account offer that provides the customer a certain percentage of cash-back on tickets booked through the transaction account issuers' credit card for a partner airline's ticket. Similarly, a customer who uses a credit card for large sums of money may be offered a ‘titanium’ card that provides various additional features such as higher maximum limit, reward points on luxury items, etc. Generally, transaction account issuers may determine the product/services for a customer, based on financial and lifestyle information of the customers.

Currently, the transaction account issuers utilize various independent techniques to target customers for transaction account offers. Various marketing techniques utilized by transaction account issuers may include, for example, random telemarketing, e-mail marketing, direct sales, and/or the like. Marketing techniques utilized by some transaction account issuers are often based more on a volume based approach, i.e. contact more and more customers with random offers thereby increasing chance of acquiring a customer for the product/service. Some transaction account issuers utilize elementary financial information to target customers for acquisition, such as whether the customer has an active bank account, whether the customer is salaried or not, etc. In most cases, customer acquisition is outsourced to multiple third party service providers. These service providers may work independent of each other, and more often than not, there is lack of co-ordination between service providers in the customer acquisition process. As a result, the customers are randomly offered different offers through different delivery channels in hope of customer acquisitions.

The randomized technique of targeting customers for products/services has various associated disadvantages. The products/services offered to the customer may not suit customer requirements, thereby causing inconvenience to the customer. The delivery channel utilized for contacting the customer for an offer may be selected randomly and may not be customer's preferred mode of correspondence, which may result in wasting communication resources. Furthermore, the customer may be contacted at a random time of year when the customer may not be in need of the offering, thereby increasing the chance of negative response from the customer.

Given the foregoing, what is needed is an effective system for transaction account issuers to intelligently acquire potential customers for relevant transaction account offerings, though a preferred delivery channel of the customer at an appropriate time.

### SUMMARY OF THE INVENTION

The present invention meets the above-mentioned needs by providing methods, systems and computer readable storage mediums for providing financial product offerings, based on a customer's financial, lifestyle and behavior related data.

An exemplary method may include receiving, by a computer based system for providing financial product offerings, user input via a customizable interface which dynamically changes interrogation fields of the customizable interface based on the user input. Data may be received from the database in response to at least one of interactively building the query and executing the query. The method may include producing, by the computer based system, a plurality of rank ordered results for comparison. The producing may use preprogrammed analytics, data from the database and user input. The results may include customer lists linked to a distinct transaction account offering and a preferred delivery channel of the distinct transaction account offering to a customer. The method may include offering, by the computer based system and through the preferred delivery channel, a transaction account from the rank ordered transaction account results to the customer. The response of the customer to the offering may be tracked, by the computer based system. The preprogrammed analytics may be adjusted for use in subsequent transaction account offerings based upon the response tracking results.

Further features and advantages, as well as the structure and operation of various embodiments, are described in detail below with reference to the accompanying drawings.

### BRIEF DESCRIPTION OF THE DRAWINGS

A more complete understanding of the invention may be derived by referring to the detailed description and claims when considered in connection with the Figures, wherein like reference numbers refer to similar elements throughout the Figures, and:

FIG. 1 is an exemplary environment in which an analytics module for providing financial product offering may be deployed, according to an embodiment;

FIG. 2 is an exemplary implementation of the analytics module for providing financial product offering, according to an embodiment;

FIG. 3 is a flowchart illustrating one example process for providing the financial product offering, according to an embodiment;

FIGS. 4-9 are screenshots of an exemplary customizable interface for inputting user input, in accordance with various embodiments of the invention;

FIG. 10 is screenshot of an exemplary customizable interface for populating interrogation fields, in accordance with various embodiments of the invention;

FIG. 11 is screenshot of an exemplary customizable interface for receiving data from database, in accordance with various embodiments of the invention; and

FIG. 12 is a block diagram of an exemplary computer system, according to an embodiment.

### DETAILED DESCRIPTION OF THE INVENTION

The detailed description of exemplary embodiments of the invention herein makes reference to the accompanying drawings and figures, which show the exemplary embodiments by way of illustration only. While these exemplary embodiments are described in sufficient detail to enable those skilled in the art to practice the invention, it should be understood that other embodiments may be realized and that logical and mechanical changes may be made without departing from the spirit and scope of the invention. It will be apparent to a person skilled in the pertinent art that this invention can also be employed in a variety of other applications. Thus, the detailed description herein is presented for purposes of illustration only and not of limitation. For example, the steps recited in any of the method or process descriptions may be executed in any order and are not limited to the order presented. Moreover, many of the functions or steps may be outsourced to or performed by one or more third parties. Furthermore, any reference to singular includes plural embodiments, and any reference to more than one component or step may include a singular embodiment or step. For the sake of brevity, conventional data networking, application development and other functional aspects of the systems (and components of the consumer operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

Functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

The term “merchant” may include any person, entity, distributor system, software, hardware, broker and/or any other entity in the distribution chain of products or services. For example, a merchant may be an on-line merchant, a retail store, a travel agency, a service and/or the like.

Phrases similar to “transaction account offering” may be interchangeably used with the terms “services”, “offerings”, and “financial product offerings”. Examples of “transaction account offerings” may include products such as transaction instruments, charge cards, credit cards, transaction cards, debit cards, insurance policies, and the like. Further, examples of services may include services such as arranging for travel plans, booking of tickets, hotel reservations and/or the like.

A term similar to “customer” may include any person, entity, software, hardware and/or the like that makes a purchase/transaction from the merchant, either directly or through an affiliate. Moreover, a “customer” may also be broadly categorized as a “consumer” (a customer who makes primarily consumer-related purchases).

A term similar to “delivery channel” may include software, hardware, a communication link and/or technique of contacting customers for transaction account offerings. Examples of a delivery channel for contacting customers may include e-mail, telemarketing, online, direct sales, and/or the like.

The systems, methods and computer program products disclosed in conjunction with various embodiments are embodied in systems and methods for intelligently targeting potential customers, to whom transaction accounts may be offered. The nomenclature “preprogrammed analytics” is only exemplary and used for descriptive purposes, and must not be construed to limit the scope.

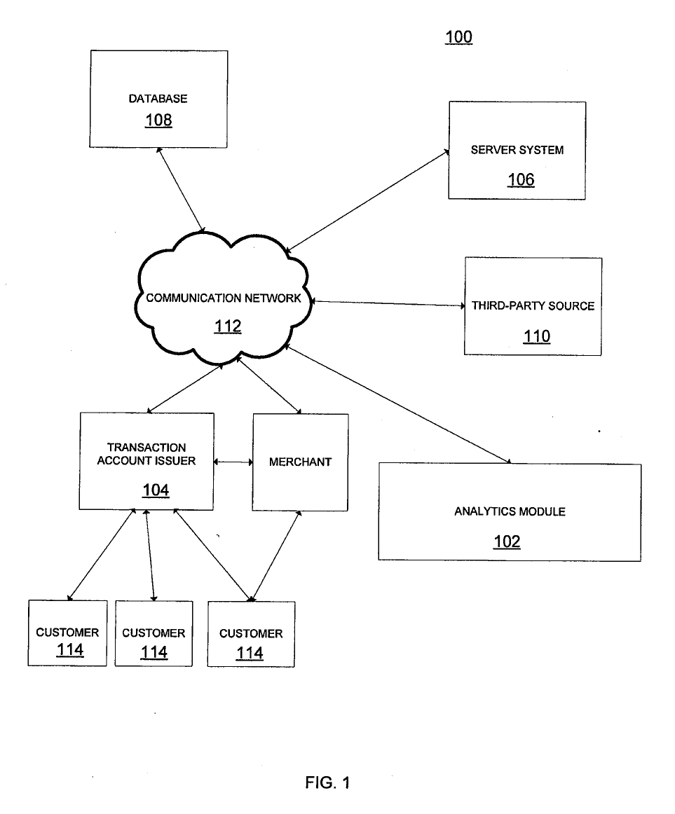

With reference to FIG. 1, an exemplary environment 100 is depicted, in which an analytics module 102 may be utilized, in accordance with an embodiment. Environment 100 may include a transaction account issuer 104, a server system 106, a database 108, third-party sources 110 and a communication network 112. Transaction account issuer 104, server system 106, database 108 and third-party sources 110 may communicate with each other over communication network 112. Examples of communication network 112 may include a wide area network (WAN), a local area network (LAN), an Ethernet, Internet, an Intranet, a cellular network, a satellite network, or any other suitable network for transmitting data. Further, communication network 112 may be implemented as a wired network, a wireless network or a combination thereof.

Transaction account issuer 104 and third-party sources 110 may include any hardware and/or software suitably configured to facilitate input, receipt and/or review of information relating to customer acquisition or any information discussed herein. Transaction account issuer 104 and third-party sources 110 may include any device (e.g., computing units) which communicates (in any manner discussed herein) with analytics module 102 via any network discussed herein. These computing units or systems may take the form of a computer or set of computers, although other types of computing units or systems may be used, including laptops, key fobs, mobile phones, notebooks, hand held computers, set-top boxes, workstations, computer-servers, main frame computers, mini-computers, PC servers, pervasive computers, network sets of computers, and/or the like. As will be appreciated by one of ordinary skill in the art, transaction account issuer 104 and third-party sources 110 may or may not be in direct contact with analytics module 102. For example, transaction account issuers 104 and third-party sources 110 may access the services of analytics module 102 through another server, which may have a direct or indirect connection to server system 106.

Transaction account issuer 104 and third-party sources 110 may include an operating system (e.g., Windows NT, 95/98/2000, OS2, UNIX, Linux, Solaris, MacOS, etc.) as well as various conventional support software and drivers typically associated with computers. Further, transaction account issuer 104 and third-party sources 110 may include any suitable personal computer, network computer, workstation, minicomputer, mainframe and/or the like. In an exemplary embodiment, access may be through a network or the Internet through a commercially available web-browser software package.

In an exemplary implementation as illustrated in FIG. 1, analytics module 102 may be deployed on server system 106. In another exemplary embodiment, analytics module 102 may be connected to server system 106 through communication network 112. Although analytics module 102 is described herein in terms of transaction account offerings (e.g., credit card products), it will be readily apparent to one ordinary skilled in the art that analytics module 102 may be deployed for other types of products such as loans, insurance plans, travel packages, retail goods and/or the like. Analytics module 102 may enable transaction account issuer 104 to intelligently target customers 114 for acquisition for transaction account offerings through an appropriate delivery channel, at an appropriate time. Further, analytics module 102 may map customers 114 to most appropriate transaction account offerings, and preferred delivery channel based on analytics performed on data related to customers 114. The data related to customers 114 may be stored in database 108 or retrieved from third-party sources 110.

The information stored on database 108 may include personal information of customers 114. The personal information may include a name, an address, current geographical location, gender, age, other demographic information, contact details, such as e-mail address, phone number, correspondence address, social security number, and/or the like. Database 108 may receive the personal information through an application form filled by customer 114 for a transaction account. Database 108 may store other information such as, transaction history, account receivable information, credit bureau information, historical transaction account offer information, historical transaction account application information, application information, financial triggers of the customers 114, lifestyle triggers of the customers 114, and/or the like.

Database 108 may store the history of applications for transaction account offerings for customers 114. Moreover, database 108 may also store credit history of customers 114, which may be retrieved from credit bureaus. Database 108 may store other financial data of the customers 114 such as, for example, income range, investment portfolio, spending patterns, share of wallet, household income, credit history, credit rating (for example, FICO rating), number of credit cards held by the visitor, number of add-on cards, number of revolving accounts, revolving amount and/or the like.

Database 108 may store lifestyle related data of customers 114. For example, lifestyle related data of customers may include whether a particular customer frequently travels by air. Lifestyle related data of customers may include whether customer spends a significant amount of money in shopping. Lifestyle related data of customers may include whether the account of the particular customer reflects a significant amount of transaction at gas stations, etc. This lifestyle related data may provide information relating to spending trends of customers 114.

Database 108 may also store behavior related data of customers 114. The behavior information of customers 114 may include Internet Protocol (IP) address, unique cookie identification data, web browsing patterns, online purchase history and/or the like.

In an exemplary embodiment, database 108 may retrieve all the above stated information from third party sources 110. Third party sources 110 may include various online service providers such as, for example, Google Analytics, Urchin Software from Google Inc., Yahoo! Web Analytics, Omniture's Site Catalyst and/or the like. Further, third party sources 110 may also include databases of an insurance company, databases of a bank, databases of partner merchants, databases of airlines, databases of a chain of retail stores and/or the like. For example, database 108 may retrieve data related to bank account of customers 114, such as account transactions, opening balance, closing balance, average balance over a period of time, interest earned over a period of time, and/or the like from third party sources 110. Similarly, database 108 may extract data relating to insurance policy of customers 114 from the database of the insurance company. Database 108 may extract data relating to status of loan taken up by customers 114 from the database of the bank. This data may be utilized in calculating current and future financial debt on customers 114.

Environment 100 may also include a data system, which may include a relational database (not shown) coupled to various other systems, illustrated in environment 100, directly or indirectly through communication network 112. The relational database may enable extraction and storage of data related to customers 114 that may be stored on third party sources 110. Database 108 may be part of the data system.

Database 108 may employ any type of database, such as relational, hierarchical, graphical, object-oriented, and/or other database configurations. Common database products that may be used to implement the databases may include DB2 by IBM (White Plains, NY), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables may be preferably the same or of the same type. However, data tables having similar, though not identical, data in the key fields may also be linked by using AGREP, for example. In accordance with one aspect of the invention, any suitable data storage technique may be utilized to store data without a standard format. Data sets may be stored using any suitable technique, including, for example, storing individual files using an ISO/DEC 7816-4 file structure; implementing a domain whereby a dedicated file may be selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

One skilled in the art will also appreciate that, for security reasons, any databases, systems, devices, servers or other components of database 108 may consist of any combination thereof at a single location or at multiple locations, wherein each database or system includes any of various suitable security features, such as firewalls, access codes, encryption, decryption, compression, decompression, and/or the like.

The invention may be described herein in terms of functional block components, screen shots, optional selections and various processing steps. It should be appreciated that such functional blocks may be realized by any number of hardware and/or software components configured to perform the specified functions. For example, system 100 may employ various integrated circuit components, e.g., memory elements, processing elements, logic elements, look-up tables, and/or the like, which may carry out a variety of functions under the control of one or more microprocessors or other control devices. Similarly, the software elements of system 100 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 100 may employ any number of conventional techniques for data transmission, signaling, data processing, network control, and/or the like. Still further, system 100 could be used to detect or prevent security issues with a client-side scripting language, such as JavaScript, VBScript and/or the like. The networking architecture between transaction account issuer 104 and server system 106 may be client-server architecture. The client-server architecture may be built on a customizable .Net (dot-Net) platform. This customizable .Net platform may be remotely dynamically updated at any suitable time. For example, downtime may be greatly reduced as a portion of the database may be remotely updated at any time without requiring reinstallation of the preprogrammed analytics. However, it may be apparent to a person ordinarily skilled in the art that various other software frameworks may be utilized to build the client-server architecture between transaction account issuer 104 and server system 106 without departing from the spirit and scope of the invention.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

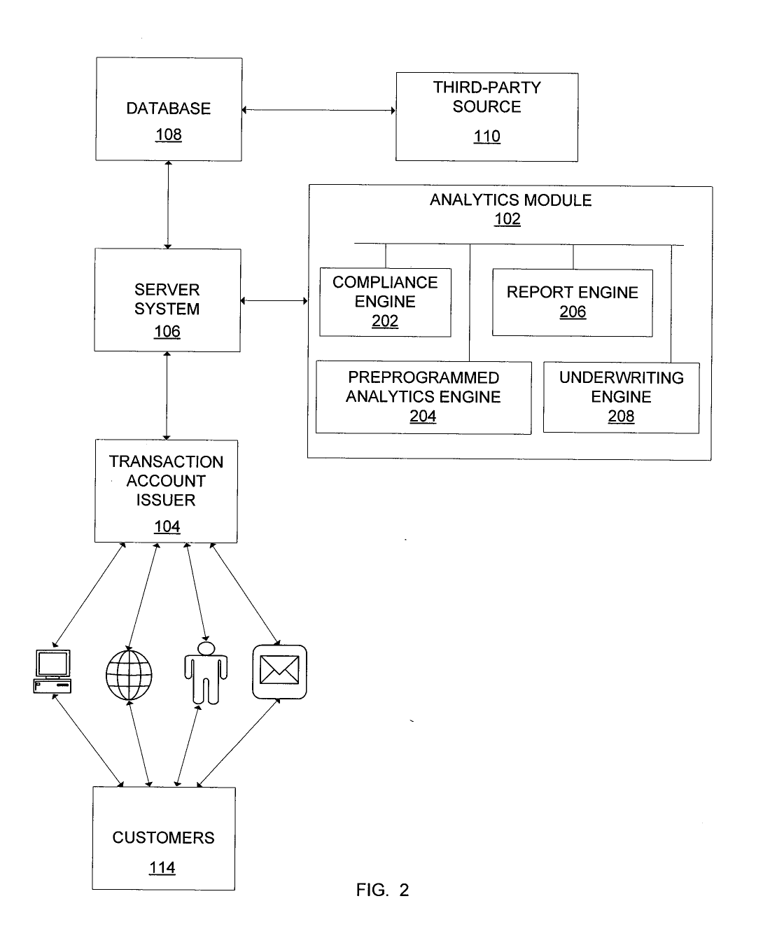

With reference to FIG. 2, an exemplary implementation of analytics module 102 is depicted. As shown in FIG. 2, analytics module 102 may include a compliance engine 202, a preprogrammed analytics engine 204, a report engine 206 and an underwriting engine 208.

Transaction account issuers may design various campaigns, at various times during the year, for offering transaction accounts to customers 114. Further, each campaign may include various campaign parameters associated with transaction account offerings. Specifically, the campaign parameters may include information about a target pool of customers, campaign budget, profit margins, and/or the like. Various embodiments may be directed towards such campaigns that offer transaction account offers. Further, the system contemplates the role of analytics module 102 in such campaigns.

Compliance engine 202 may be capable of receiving a user input via a customizable interface. The customizable interface may be capable of dynamically changing interrogation fields based at least in part on the user input. The user input provided through the customizable interface may provide information regarding a campaign unique identifier, description of campaign, campaign definition, type of campaign, and/or the like. For example, transaction account issuer 104 may input a unique name for offering campaign that may serve as a unique identifier for referencing the offering campaign in the future and for storage purposes. Furthermore, transaction account issuer 104 may input a description of the campaign serving as an overview of the campaign. The description may provide brief information about the offers for which the campaign may be aimed Transaction account issuer 104 may provide information regarding the type of campaign such as, for example, cross selling of new cards, upgrades on existing offers, external acquisition of customers 114 and/or the like. Transaction account issuer 104 may input campaign sub type such as ‘charge’, ‘lending’, ‘multi’ and/or the like.

Further, transaction account issuer 104 may populate the interrogation field for a preferred delivery channel, using the customizable interface, for a particular transaction offering. The preferred delivery channel may be inputted by transaction account issuer 104 in a rank ordered manner based at least in part on a cost associated with the delivery channel. In one embodiment, the preferred delivery channel may be automatically inputted by the system (e.g. based upon historical results). Examples of the delivery channel may include e-mail, telemarketing, online, direct sales, and the like.

Transaction account issuer 104 and/or a third party may also populate fields such as bank relationship exclusions, credit card exclusions, offer exclusions, country exclusions, global exclusions, transaction account campaign specific exclusions through the customizable interface. For example, the bank relationship exclusion may include business policy related exclusion such as application of standard customer level exclusions, application of organization level exclusions, and/or the like. Further, bank relationship exclusions may also include risk policy related exclusions such as bank account tenure threshold, limit on delinquency on bank loans, account over-drawn, negative bureau information, etc. Furthermore, the bank relationship exclusion may include contact suppression related exclusion such as threshold of number of contact attempts made for customers 114.

In various embodiments, interrogation fields may be dynamically updated in the customizable interface, based on the user input provided by transaction account issuer 104, a third party and/or dynamically updated automatically by the system based on historically collected information. The interrogation fields may be changed according to parameters (e.g. those entered by transaction account issuer 104) in the form of user input. Fields that may be relevant to type of offering campaign, campaign definition and other parameters may be displayed on the customizable interface. The interrogation fields may be populated with data that provides various criterions for selection of customers for a particular offering. For example, transaction account issuer 104 may provide information that only customers with an average bank balance of $25,000 may be eligible for a predefined offering.

A database query may be interactively built, based on population of the interrogation fields (e.g. by transaction account issuer 104), for matching a selection of transaction account offerings to a population of customers 114. Specifically, the various criterions for selection of transaction account offerings to a population of customers 114 may be utilized in forming the database query. The database query may be restricted based on various parameters, such as bank relationship exclusions, credit card exclusions, offer exclusions, country exclusions, global exclusions, transaction account campaign specific exclusions, net present value, average account balance and/or the like.

In an embodiment, server system 106 addresses the database query to database 108 for extraction of required data related to customers 114. Server system 106 receives data from database 108 in response to the execution of the database query by database 108. Database 108 may return language specific collections of objects which satisfy a query predicate expressed as logical operators e.g. >, <, >=, <=, AND, OR, NOT, GroupBY, etc. Specifically, database 108 may provide information of customers 114 that satisfy the criterions (e.g. those set by transaction account issuer 104) for a predefined transaction account offering based on any suitable input (e.g. user input). The information associated with customers 114 returned by database 108 may include name, address, email, telephone number, preferred mode of communication, customer ID, account ID, transaction history, account receivable information, credit bureau information, historical transaction account offer information, historical transaction account application information, application information, financial triggers of the customer, lifestyle triggers of the customer, or thee like.

Analytics module 102 may receive the data retrieved from database 108. Customer information may be selected from database 108 (e.g. by Transaction account issuer 104 using the customizable interface).

Analytics module 102 may utilize the data retrieved from database to produce a rank ordered list of transaction account offerings mapped to customers 114. The rank ordered list of transaction account offerings for customers 114 may include a distinct transaction account offering, preferred delivery channel and preferred time for contacting customers 114. Various parameters may be considered while determining preferred transaction account offerings for customers 114. Preprogrammed analytics engine 204 may calculate Net Present Value (NPV) of customers 114 for identifying a distinct transaction account offering for customers 114. The list of customers 114 may be ranked in a descending order such that the NPV may be maximized. In another exemplary embodiment, preprogrammed analytics engine 204 may calculate expected spend of customers for the particular transaction account offering. The list of customers 114 may be ranked in a descending order such that ‘expected spend’ is maximized. ‘Expected spend’ may be amount of money value a customer may be expected to spend using the particular offering.

Preprogrammed analytics engine 204 may calculate number of customers 114 responding to a transaction account offering for different preferred delivery channel(s). The list of transaction account offerings may be ranked in a descending order such that number of customers responding to the particular transaction account offering may be maximized.

Preprogrammed analytics engine 204 may calculate return on investment on the particular transaction account offering. The list of customers 114 may be ranked in a descending order such that return on investment on the particular transaction account offering for customers 114 may be maximized for a pre-defined period of time. The pre-defined period may equal 1 year. For example, the pre-defined period may equal 5 years. However, a person of ordinarily skill in the art will appreciate that any other suitable periods may be used while calculating the profitability margin without deviating from the spirit and scope.

A profitability margin may also be calculated based on budget constraints of the campaign. For example, the amount of investment for the campaign should not exceed an allotted budget for the campaign.

Preprogrammed analytics engine 204 may identify transaction account offerings based upon matching attributes of the distinct transaction accounts to complementary lifestyle and behavioral data of customers 114 retrieved from database 108. Preprogrammed analytics engine 204 may utilize lifestyle related data of customers 114 retrieved from database 108 for producing the list of transaction account offerings. For example, if credit card information of a customer reveals that the customer is a frequent-flier, then that particular customer may be provided with a credit card offering, which may provide a certain percentage of cash-back on tickets booking.

In response to preprogrammed analytics engine 204 determining multiple transaction account offerings are suitable for a particular customer, the transaction account offerings may be ranked based on number of matching attributes of the transaction account offerings with information related to the particular customer. The transaction account offerings may be presented to the particular customer in a customizable sequence of ranking of the offerings such as descending or ascending order.

Further, preprogrammed analytics module 204 may utilize information related to customers 114 to determine preferred delivery channels. The Preferred delivery channel may be determined for a particular customer based on at least one of associated cost of delivery channel to transaction account issuer 104, customer preference, past responses on the delivery channel and/or the like. Cost to transaction account issuer 104 may be amount of money transaction account issuer 104 requires spending for using the communication link such as printing costs for mailings sent to the particular customer. The cost to transaction account issuer may include compensation of telemarketing operators utilized to extend the offering to the particular customer and associated phone systems utilized. The preferred mode of communication of a particular customer may be taken into consideration while determining the preferred delivery channel for the particular customer. Information about the particular customer's preferred mode of communication may be extracted from application form of the particular customer stored in database 108 and/or through third party data. Furthermore, the preferred delivery channel may be determined based on previous success rate of the delivery channel and anticipated success rate of the delivery channel. The preferred delivery channel may be determined based on time required to use the delivery channel.

A preferred time of communication for contacting the particular customer for a suitable offering may also be determined by preprogrammed module 204. Information regarding preferred time of contacting the particular customer may be extracted from application form filled by the particular customer and/or through third party data. The preferred time to contact may be determined based on the lifestyle related data of the particular customer. For example, if the particular customer travels by air frequently only during holiday season, then a credit card offering him/her a discount on air tickets should be offered to him/her just before or during the holiday season.

With reference to FIG. 2, report engine 206 may receive the rank ordered results from preprogrammed analytics 204. Report engine 206 may output a report, which includes list of customers 114 linked to a distinct transaction account offering, a preferred delivery channel of the distinct transaction account offering and a preferred time of communicating with customers 114. The structure, order, format and appearance of the rank ordered results, in the report, may be configured based on the user input. For example, metadata regarding the formatting and structure of the rank ordered results may be inputted by transaction account issuer 104 using the customizable interface and/or provided by a computer coupled to the system. Transaction account issuer 104 may select type of output file, for the report, from a CSV file format, MS excel file format, MS Word format and/or the like. However, it may be apparent to a person of ordinary skill in the art that various other file formats may be utilized to output the rank ordered results.

In an exemplary embodiment, transaction account issuer 104 may receive the report from report engine 206. Transaction account issuer 104 may offer the transaction account offerings to customers 114 through the preferred delivery channel, based on the rank ordered results included in the report. Analytics module 102 may be capable of offering a transaction account offering to customers 114 directly from the rank ordered results through the preferred delivery channel and at the preferred time.

Analytics module 102 may track response of customers 114 to the transaction account offering. Analytics module 102 may be configured to track responses of customers 114 to offering for a predefined period of time. The predefined period of time to track the responses of customers 114 may be inputted (e.g. by transaction account issuer 104 using the customizable interface and/or provided by a coupled computer) to the system. Analytics module 102 may be adapted to track various responses such as, positive, negative and no response. Analytics module 102 may adjust the preprogrammed analytics stored in preprogrammed analytics engine 204, based on the tracked responses, for use in subsequent transaction account offerings. For example, if a particular customer does not respond to offerings through a particular delivery channel for the predefined period of time, then preprogrammed analytics engine 204 may be updated to remove the particular delivery channel as the preferred delivery channel for that particular customer. Preprogrammed analytics engine 204 may be updated, and subsequent transaction account offerings may be offered to the particular customer through a different delivery channel.

In response to a particular customer responding positively to a transaction account offering, the particular customer may be asked to fill out an application form to input personal and financial information. Underwriting engine 208 may create an underwriting decision in response to the application form filled by the particular customer. The underwriting decision may be based at least in part on a fraud check and/or a credit worthiness evaluation. For example, if credit history of a particular customer reveals that the customer has been involved in a case of a fraud or a check bounce event, then that particular customer may be flagged or not offered the particular offering. Credit worthiness for a particular customer may be determined based on the data received from database 108 and/or third party data.

Underwriting engine 208 may track the result of the underwriting decision. Analytics module 102 may adjust the preprogrammed analytics, based on the tracked result of the underwriting decision, for use in subsequent transaction account offerings. For example, if a particular customer is tracked to have been involved in fraud check cases, then preprogrammed analytics engine 204 may be adjusted to blacklist the particular customer in database 108.

In response to the particular customer withstanding the various checks (e.g., fraud check, credit worthiness check and/or the like), the underwriting engine 208 may issue the distinct transaction account identified for the particular customer to the particular customer.

Analytics module 102 may track profitability of the issued transaction account to the particular customer. The profitability may be tracked based on one or more profitability tracking variables such as successful transaction account issuance, customer response to a solicitation, value of spend, revolve, payment activity, delinquencies, customer behavior of spend and/or the like. Analytics module 102 may adjust preprogrammed analytics engine 204 for use in subsequent offerings, based upon the profitability tracking results.

Analytics module 102 may also update the preprogrammed analytics for subsequent offerings based on at least one of value of spend, transactions, customer revolve, other transaction account activity, payment history, delinquencies, spend behavior of the customers 114 on the issued transaction account and/or the like.

Analytics module 102 may reassess the transaction account offering to customers 114 in response to receiving a negative response from a particular customer. Preprogrammed analytics engine 204 may produce a second customer list appended with second rank order of transaction account offerings and a second preferred delivery channel for the transaction account offerings. The second identified transaction account may be of the same type of transaction account as the transaction account previously offered to the particular customer. The second identified delivery channel may be of the same type of delivery channel as previously used to offer the transaction account to particular customers.

Analytics module 102 or transaction account issuer 104 may offer the second transaction account offering through the second identified delivery channel, to particular customers, from whom no response is received on the previous transaction account offering.

Preprogrammed analytics engine 204 may be capable of receiving unsolicited customer application data from a particular customer for an unsolicited transaction account. Underwriting engine 208 may create an underwriting decision on application data of the particular customer for the unsolicited transaction account. Underwriting engine 208 may issue the unsolicited transaction account to the unsolicited customer based on the underwriting decision. Analytics module 102 may track profitability of the issued unsolicited transaction account and may adjust the preprogrammed analytics stored preprogrammed analytics engine 204 in for use in subsequent transaction account offerings.

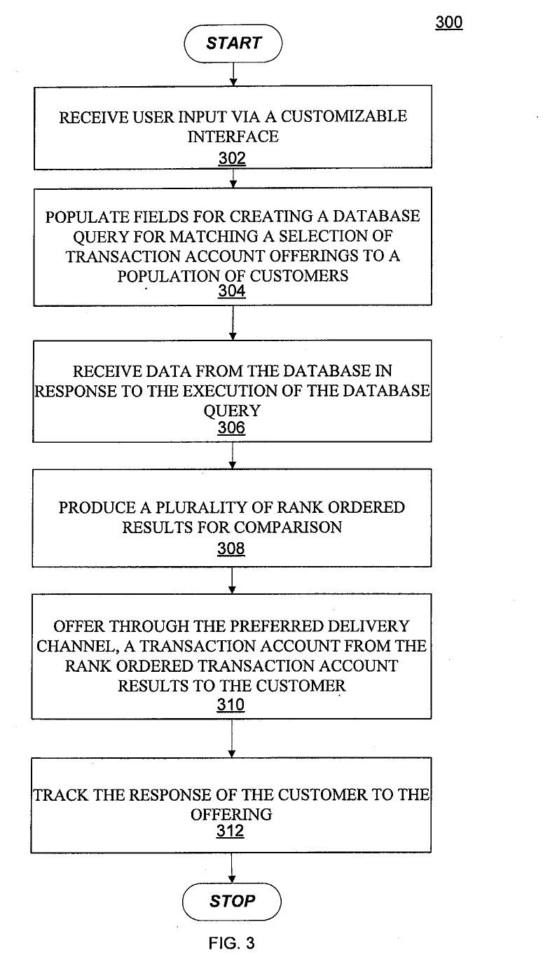

FIG. 3 is a flowchart illustrating an example process 300 for providing financial product offerings. Analytics module 102 may receive a user input, provided by transaction account issuer 104, for providing transaction account offerings via the customizable interface (step 302). The customizable interface may dynamically change interrogation fields based on the user input.

Transaction account issuer 104 may provide the inputs to populate the interrogation fields for creating the database query for matching a selection of transaction account offerings to a population of customers 114 (step 304). The database query may be restricted based on at least one of bank relationship exclusions, credit card exclusions, offer exclusions, country exclusions, global exclusions, transaction account campaign specific exclusions, net present value, average account balance and/or the like.

Database 108 may store data associated with at least one of transaction history, account receivable information, credit bureau information, historical transaction account offer information, historical transaction account application information, application information, financial triggers of the customer, and lifestyle triggers of the customer. Database 108 may retrieve this information from third party sources 110.

Analytics module 102 may receive, via server system 106, the data/information related to customers 114 from database 108 in response to at least one of interactively building and executing the query, by populating the interrogation fields. (Step 306).

Analytics module 102 may produce a plurality of rank ordered results for comparison (step 308). The rank ordered results may be produced using preprogrammed analytics stored in preprogrammed analytics engine 204, data from database 108 and user input. The results may include list of customers 114 linked to distinct transaction account offerings and preferred delivery channels of the distinct transaction account offerings to customers 114. The ranking of transaction account offerings may be at least partially based upon at least one of maximizing expected lifetime profitability, maximize expected spend, maximize expected responders, maximize first year return on investment, maximizing fifth year return on investment, budget constraints and/or the like. The selection of the identified transaction account may be based upon matching attributes of the distinct transaction account to complementary data of the customers on a customer list from the database. The delivery channel may include at least one of online, mail, telephone, in person and direct mail. The selection of the preferred delivery channel may be based upon at least one of cost of the delivery channel, time required to use the delivery channel, previous success rate of the delivery channel and anticipated success rate of the delivery channel.

Analytics module 102 may offer transaction account offerings from the rank ordered results to customers 114 through the preferred delivery channels (step 310). Transaction account issuer 104 may offer transaction account offerings from the rank ordered results to customers 114 through the preferred delivery channels.

Analytics module 102 may track responses of customers 114 to the transaction account offerings (step 312). Analytics module 102 may be adapted to track various responses such as, positive, negative and no response. Analytics module 102 may adjust the preprogrammed analytics stored in preprogrammed analytics engine 204 for use in transaction account offerings, based upon the response tracking results.

In response to receiving a positive response from a particular customer, the customer may be asked to fill out an application form to input personal and financial information. Underwriting engine 208 may create an underwriting decision in response to the application form filled by the particular customer. The underwriting decision may be based at least in part on a fraud check and/or a credit worthiness evaluation.

Analytics module 102 may track results of the underwriting decision. Analytics module 102 may adjust the preprogrammed analytics stored for use in subsequent transaction account offerings, based upon the underwriting tracking results.

Underwriting engine 208 may issue a transaction account to customers 114 based on a positive result from the tracking of underwriting decision. Analytics module 102 may also track profitability for transaction account issuer 104 from the transaction account issued to customers 114. The profitability tracking may be based on one or more profitability tracking variables, such as successful transaction account issuance, customer response to a solicitation, value of spend, revolve, payment activity, delinquencies, customer behavior, and/or the like. Analytics module 102 may adjust the preprogrammed analytics stored in preprogrammed analytics engine 204 for use in subsequent offerings, based upon the profitability tracking results. Analytics module 102 may update the preprogrammed analytics based on at least one of value of spend, transactions, customer revolve, other transaction account activity, payment history, delinquencies, spend behavior of the customer and/or the like.

Analytics module 102 may reassess the transaction account offerings to the customer in response of receiving a negative response from the customer after a predetermined period of time. Preprogrammed analytics engine 204 may produce a second customer list appended with second rank ordered, transaction account offerings and a second preferred delivery channel of the account offerings. Analytics module 102 and/or transaction account issuer 104 may offer the second identified transaction account offering through the second identified delivery channel to the customer.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

While the steps outlined above represent a specific embodiment, practitioners will appreciate that there are any number of computing algorithms and user interfaces that may be applied to create similar results. The steps are presented for the sake of explanation only and are not intended to limit the scope of the invention in any way.

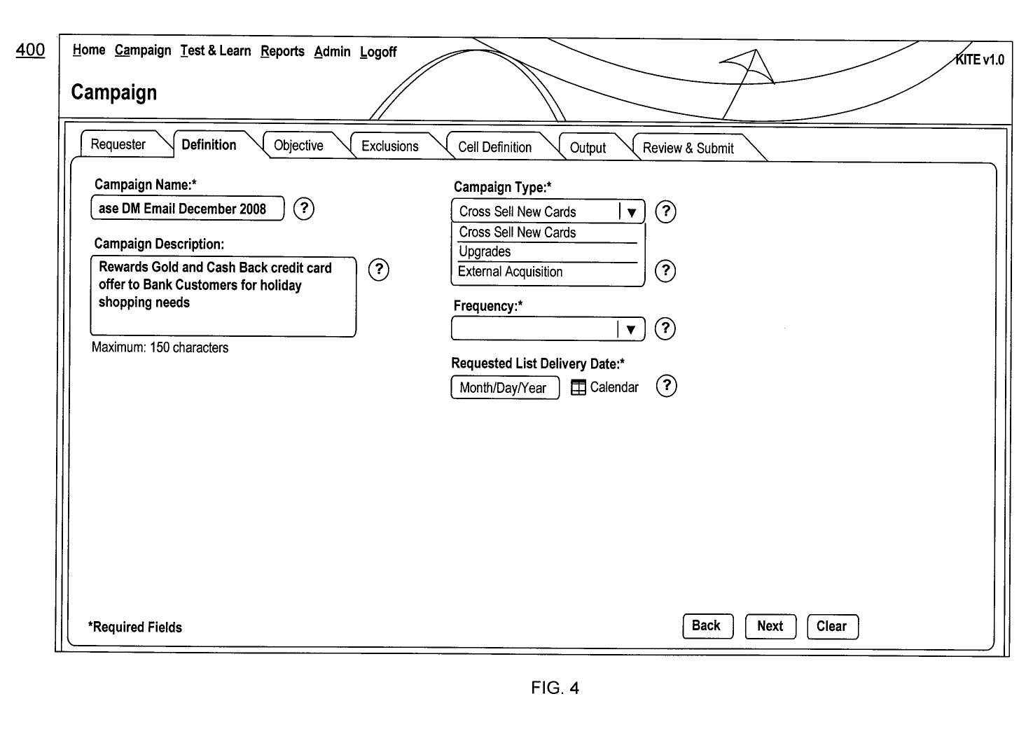

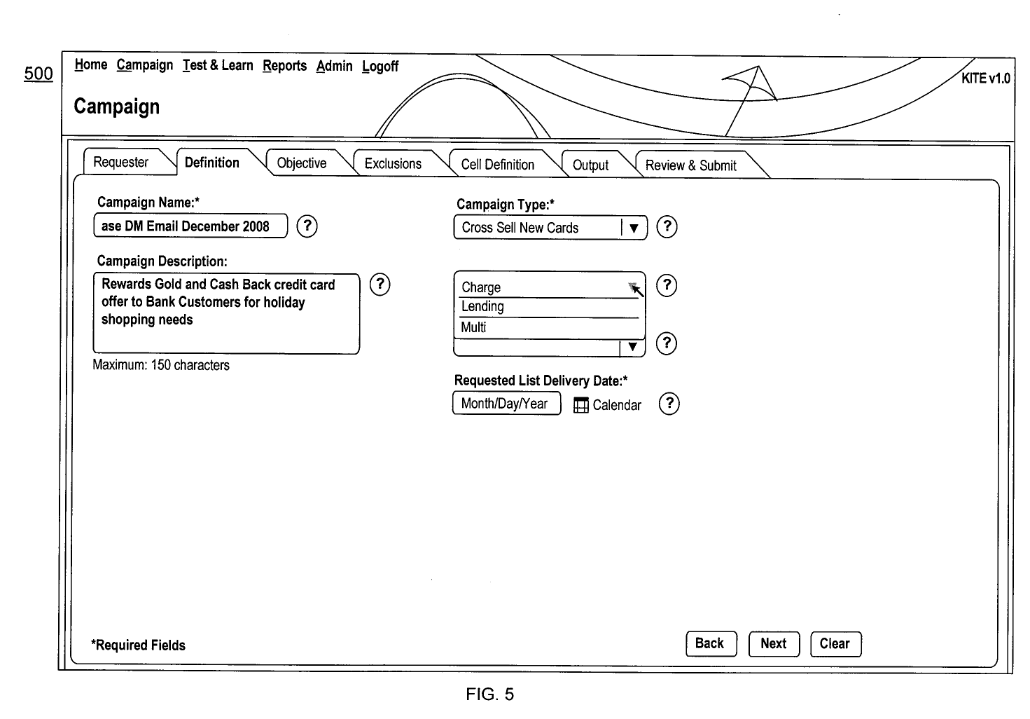

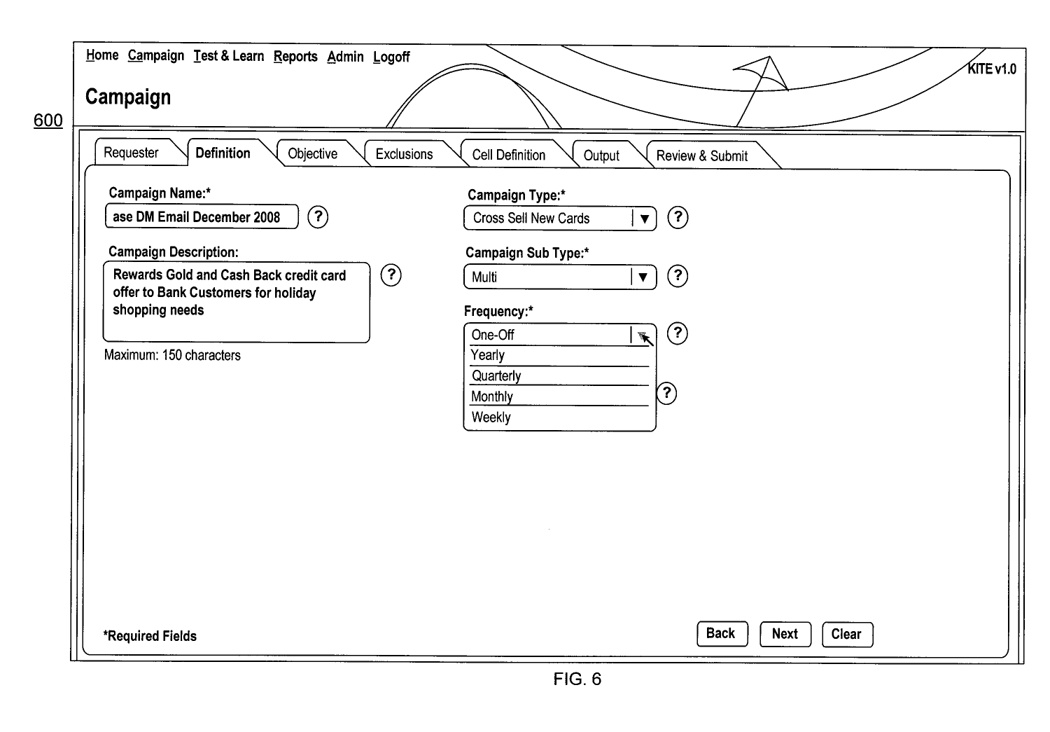

Referring to FIGS. 4-9, a process of receiving user input (step 302) by transaction account issuer 104 using an exemplary customizable interface is illustrated. Referring to FIG. 4, an interface 400 is provided wherein transaction account issuer 104 may enter a unique campaign name to identify the particular transaction account offering campaign. Transaction account issuer 104 may enter a description of the offering campaign to provide an overview or objective of the offering campaign. Transaction account issuer 104 may provide information regarding the type of offering campaign such as cross sell new cards, upgrades on existing offers, external acquisition of customers and the like. Referring to FIG. 5, an interface 500 is provided wherein transaction account issuer 104 may input campaign sub type i.e. ‘charge’, ‘lending’, ‘multi’ and/or the like. Referring to FIG. 6, a report interface 600 may be provided wherein transaction account issuer 104 may input frequency of campaign and delivery date of rank ordered results of the offering campaign.

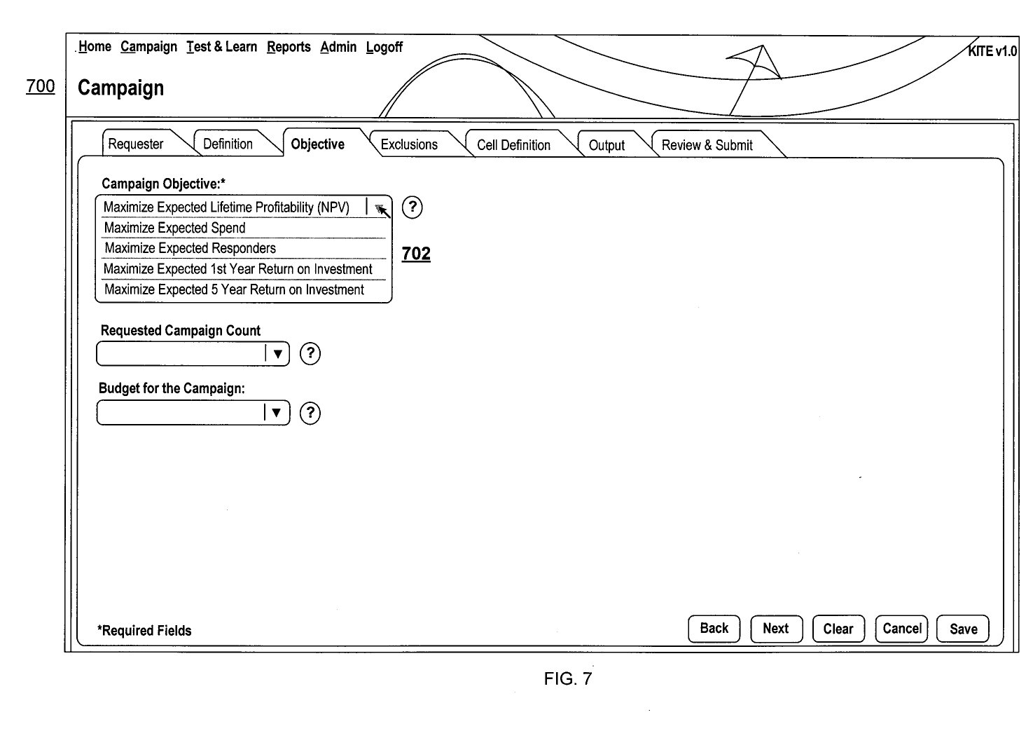

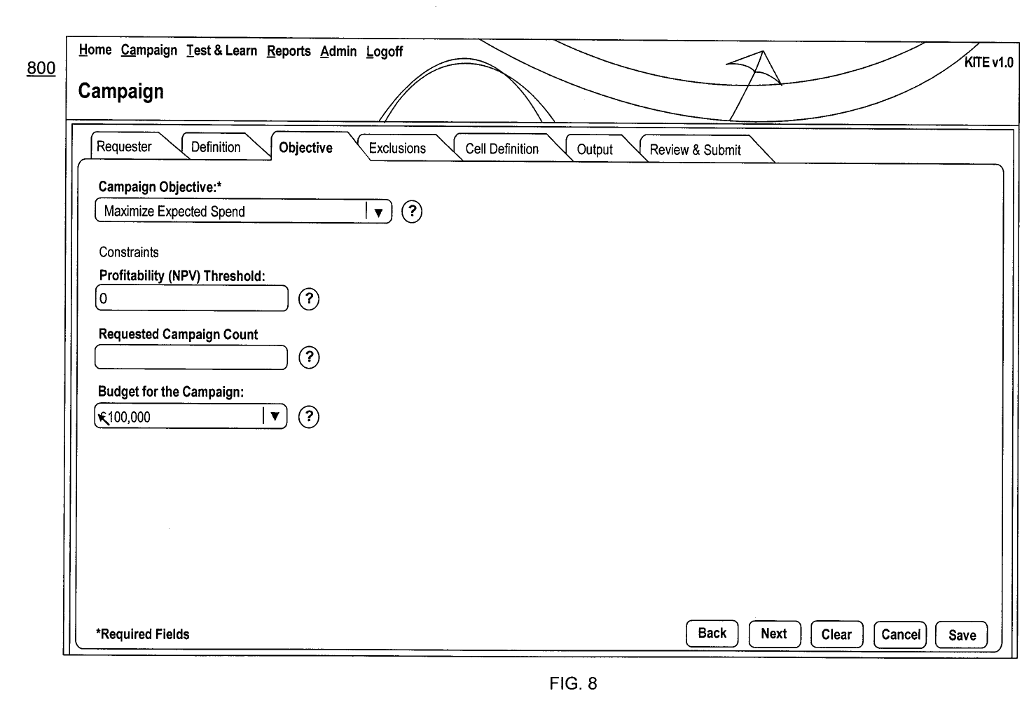

Referring now to FIG. 7, an interface 700 is disclosed wherein an option to select campaign objective from a list 702 may be provided. Interface 700 may provide an option to input Profitability (NPV) threshold, requested campaign count and budget for campaign (as shown in FIG. 8). Referring to FIG. 8, an interface 800 is disclosed, the interface 800 may provide an option for transaction account issuer 104 to input various campaign objective constraints such as profitability (NPV) threshold, requested campaign count, budget for campaign, etc.

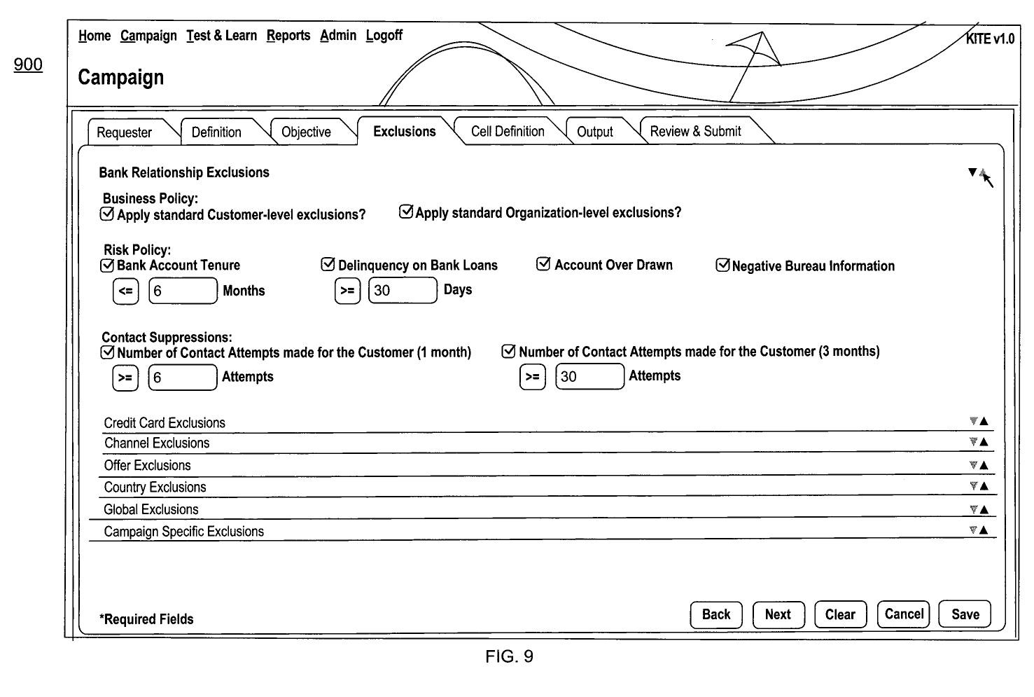

Referring now to FIG. 9, an interface 900 is disclosed which provide an option to input bank relationship exclusions, credit card exclusions, offer exclusions, country exclusions, global exclusions, transaction account campaign specific exclusions. These inputs may dynamically change the interrogation fields of the customizable interface.

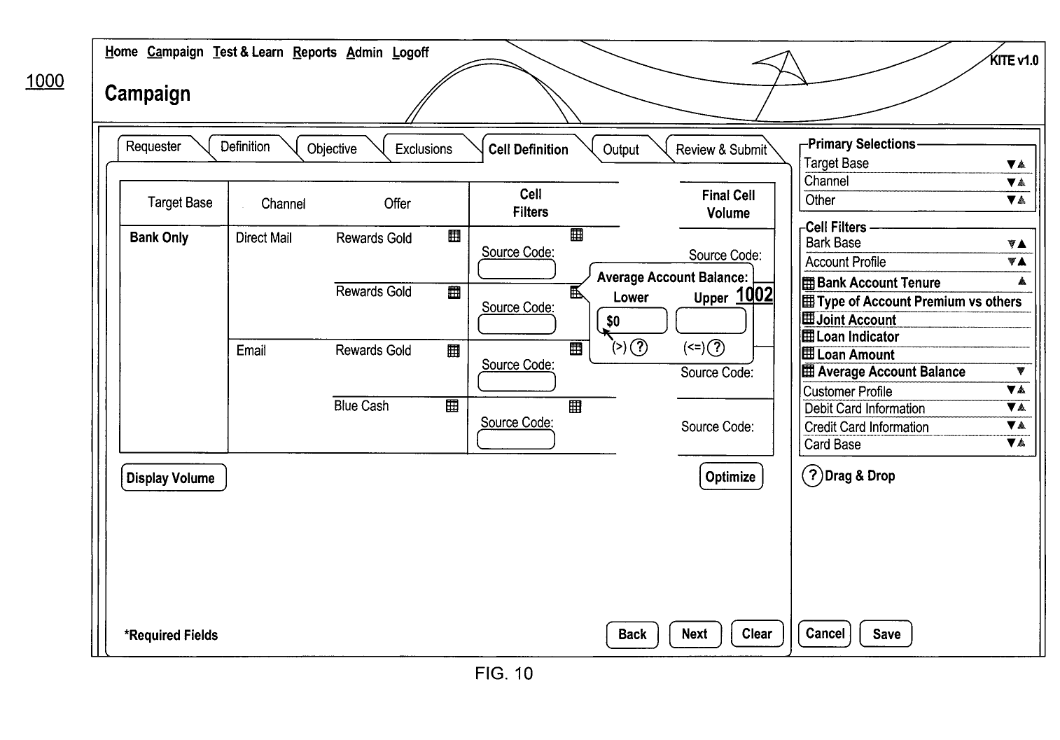

Referring now to FIG. 10, an interface 1000 for population of fields (step 304) is illustrated, according to an embodiment. The fields may be populated based on the user input provided by transaction account issuer 104 (described in conjunction with FIGS. 4-9), inter-related fields such as target base, channel, offer and cell filters may be formed. Field 1002 “Average account balance” may be deployed as a pop-up mini-screen with options setting maximum and minimum levels of average account balance for a corresponding offering (“Reward Gold”) through corresponding channel (“e-mail”), as shown in FIG. 10. Data from the populated fields may be utilized by analytics module 102 to create the database query to extract the rank ordered results.

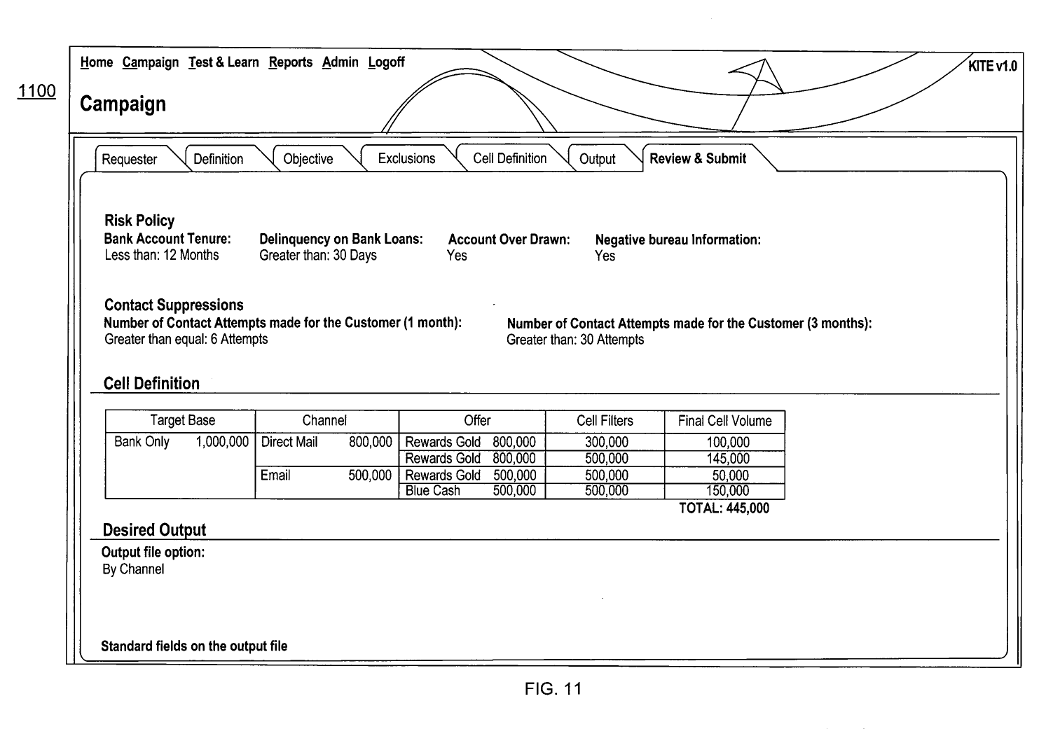

Referring now to FIG. 11, a report interface 1100 for displaying a preview of data received from database 108 is provided, according to an embodiment. As shown in FIG. 11, report interface 1100 provides a preliminary statistics of offerings and delivery channel. Report interface 1100 provides an option for transaction account issuer 104 to confirm inputs entered by transaction account issuer 104.

Preprogrammed analytics engine 204 may utilize the data retrieved from database 108 to produce plurality of rank ordered results for comparison, from which transaction account offerings may be provided to customers 114. Analytics module 102 may track the response of the offerings and may adjust the preprogrammed analytics, based on the tracked responses, to increase the effectiveness of preprogrammed analytics engine 204 to intelligently target customers 114 for transaction account offerings.

The present invention (i.e., analytics module 102, process 300, any part(s) or function(s) thereof) may be implemented using hardware, software or a combination thereof, and may be implemented in one or more computer systems or other processing systems. However, the manipulations performed by the present invention were often referred to in terms, such as comparing or checking, which are commonly associated with mental operations performed by a human operator. No such capability of a human operator is necessary, or desirable in most cases, in any of the operations described herein, which form a part . Rather, the operations are machine operations. Useful machines for performing the operations in the present invention may include general-purpose digital computers or similar devices.

In fact, in accordance with an embodiment, the present invention is directed towards one or more computer systems capable of carrying out the functionality described herein. An example of the computer based systems includes a computer system 1200, which is shown in FIG. 11.

Computer system 1200 includes at least one processor, such as a processor 1202. Processor 1202 may be connected to a communication infrastructure 1204, for example, a communications bus, a cross over bar, a network, and the like. Various software embodiments are described in terms of this exemplary computer system 1200. After reading this description, it will become apparent to a person skilled in the relevant art(s) how to implement the present invention using other computer systems and/or architectures.

Computer system 1200 includes a display interface 1206 that forwards graphics, text, and other data from communication infrastructure 1204 (or from a frame buffer which is not shown in FIG. 11) for display on a display unit 1208.

Computer system 1200 may include a main memory 1210, such as random access memory (RAM), and may also include a secondary memory 1212. Secondary memory 1212 may include a hard disk drive 1214 and/or a removable storage drive 1216, representing a floppy disk drive, a magnetic tape drive, an optical disk drive, etc. Removable storage drive 1216 reads from and/or writes to a removable storage unit 1218 in a well known manner. Removable storage unit 1218 may represent a floppy disk, magnetic tape or an optical disk, and may be read by and written to by removable storage drive 1216. As will be appreciated, removable storage unit 1218 includes a computer usable storage medium having stored therein, computer software and/or data.

In accordance with various embodiments, secondary memory 1212 may include other similar devices for allowing computer programs or other instructions to be loaded into computer system 1200. Such devices may include, for example, a removable storage unit 1220, and an interface 1222. Examples of such may include a program cartridge and cartridge interface (such as that found in video game devices), a removable memory chip (such as an erasable programmable read only memory (EPROM), or programmable read only memory (PROM)) and associated socket, and other removable storage units 1220 and interfaces 1222, which allow software and data to be transferred from removable storage unit 1220 to computer system 1200.

Computer system 1200 may include a communication interface 1224. Communication interface 1224 allows software and data to be transferred between computer system 1200 and external devices. Examples of communication interface 1224 include, but may not be limited to a modem, a network interface (such as an Ethernet card), a communications port, a Personal Computer Memory Card International Association (PCMCIA) slot and card, and the like. Software and data transferred via communication interface 1224 may be in the form of a plurality of signals, hereinafter referred to as signals 1226, which may be electronic, electromagnetic, optical or other signals capable of being received by communication interface 1224. Signals 1226 may be provided to communication interface 1224 via a communication path (e.g., channel) 1228. Communication path 1228 carries signals 1226 and may be implemented using wire or cable, fiber optics, a telephone line, a cellular link, a radio frequency (RF) link and other communication channels.

In this document, phrases similar to “computer program medium” and “computer usable medium” are used to generally refer to non-transitory media such as removable storage drive 1216, a hard disk installed in hard disk drive 1214, signals 1226, and the like. These computer program products provide software to computer system 1200. The present invention is directed to such computer program products.

Computer programs (also referred to as computer control logic) may be stored in main memory 1210 and/or secondary memory 1212. Computer programs may also be received via the communication interface 1204. Such computer programs, when executed, enable computer system 1200 to perform the features, as discussed herein. In particular, the computer programs, when executed, enable processor 1202 to perform the features. Such computer programs may represent controllers of computer system 1200.

In accordance with an embodiment, where the invention is implemented using a software, the software may be stored in a computer program product and loaded into computer system 1200 using removable storage drive 1216, hard disk drive 1214 or communication interface 1224. The control logic (software), when executed by processor 1202, causes processor 1202 to perform the functions as described herein.

In another embodiment, the present invention is implemented primarily in hardware using, for example, hardware components such as application specific integrated circuits (ASIC). Implementation of the hardware state machine so as to perform the functions described herein will be apparent to persons skilled in the relevant art(s).

In yet another embodiment, the present invention is implemented using a combination of both the hardware and the software. While the steps outlined above represent a specific embodiment of the invention, practitioners will appreciate that there are any number of computing algorithms and user interfaces that may be applied to create similar results. The steps are presented for the sake of explanation only and are not intended to limit the scope of the invention in any way.

The present invention is described herein with reference to system architecture, block diagrams and flowchart illustrations of methods, and computer program products according to various aspects of the invention. It will be understood that each functional block of the block diagrams, screenshots and the flowchart illustrations, and combinations of functional blocks in the block diagrams, screenshots and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

The computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flow diagram illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, hypertexts, hyperlinks, web forms, popup windows, prompts and the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention. It should be understood that the detailed description and specific examples, indicating exemplary embodiments of the invention, are given for purposes of illustration only and not as limitations. Many changes and modifications within the scope of the instant invention may be made without departing from the spirit thereof, and the invention includes all such modifications. Corresponding structures, materials, acts, and equivalents of all elements in the claims below are intended to include any structure, material, or acts for performing the functions in combination with other claim elements as specifically claimed. The scope of the invention should be determined by the appended claims and their legal equivalents, rather than by the examples given above. Reference to an element in the singular is not intended to mean “one and only one” unless explicitly so stated, but rather “one or more.” Moreover, where a phrase similar to “at least one of A, B, and C” or “at least one of A, B, or C” is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

We claim:

1. A method comprising:
receiving, by a computer based system for providing financial product offerings, user input via a customizable interface which dynamically changes interrogation fields of the customizable interface based on the user input;
populating, by the computer based system and based on the user input, fields for creating a database query for matching a selection of transaction account offerings to a population of customers;
receiving, by the computer based system, data from the database in response to at least one of interactively building the query and executing the query;
producing, by the computer based system, a plurality of rank ordered results for comparison, wherein the producing uses preprogrammed analytics, data from the database and user input, and wherein the results include customer lists linked to a distinct transaction account offering and a preferred delivery channel of the distinct transaction account offering to a customer;
offering, by the computer based system and through the preferred delivery channel, a transaction account from the rank ordered transaction account results to the customer; and
tracking, by the computer based system, the response of the customer to the offering, wherein the preprogrammed analytics are adjusted for use in subsequent transaction account offerings based upon the response tracking results.

2. The method of claim 1, further comprising:
creating, by the computer based system, an underwriting decision in response to receiving an application from a customer; and
tracking, by the computer based system, the results of the underwriting decision, wherein the preprogrammed analytics for use in subsequent transaction account offerings are adjusted based upon the underwriting tracking results.

3. The method of claim 2, further comprising:
issuing, by the computer based system, a transaction account to the customer; and
tracking, by the computer based system, profitability of the transaction account to a user, wherein the preprogrammed analytics for use in subsequent offerings are adjusted, based upon the profitability tracking results.

4. The method of claim 3, wherein the profitability tracking results include profitability tracking variables, wherein the profitability tracking variables comprise at least one of successful transaction account issuance, customer response to a solicitation, value of spend, revolve, payment activity, delinquencies, and customer behavior.

5. The method of claim 3, wherein the adjusting, by the computer based system, the preprogrammed analytics for subsequent offerings based upon the profitability tracking results further comprises updating the preprogrammed analytics based on at least one of value of spend, transactions, customer revolve, other transaction account activity, payment history, delinquencies, and spend behavior of the customer.

6. The method of claim 1, wherein the database comprises data associated with at least one of: transaction history, account receivable information, credit bureau information, historical transaction account offer information, historical transaction account application information, application information, financial triggers of the customer, lifestyle triggers of the customer, and third party sources.

7. The method of claim 1, wherein the ranking of transaction account offerings is at least partially based upon at least one of maximizing expected lifetime profitability (NPV), maximize expected spend, maximize expected responders, maximize first year return on investment, maximizing fifth year return on investment and budget constraints.

8. The method of claim 1, wherein the delivery channel comprises at least one of online, mail, telephone, in person and direct mail.

9. The method of claim 2, wherein the underwriting decision is based at least in part on at least one of a fraud check and a credit worthiness evaluation.

10. The method of claim 1, wherein the computer based system may at least partially comprise a client-server architecture.

11. The method of claim 10, wherein at least a portion of the database may be remotely updated without requiring reinstallation of the preprogrammed analytics at any time.

12. The method of claim 10, wherein the client-server architecture is built on a customizable .Net platform.

13. The method of claim 1, wherein the database query may be restricted based on at least one of bank relationship exclusions, credit card exclusions, offer exclusions, country exclusions, global exclusions, transaction account campaign specific exclusions, NPV, and average account balance.

14. The method of claim 1, further comprising a data system, wherein the data system comprises a relational database coupled to other systems by one of directly and indirectly.

15. The method of claim 1, wherein the selection of the preferred delivery channel is based upon at least one of cost of the delivery channel, time required to use the delivery channel, previous success rate of the delivery channel and anticipated success rate of the delivery channel.

16. The method of claim 1, wherein the selection of the identified transaction account is based upon matching attributes of the distinct transaction account to complementary data of the customers on a customer list from the database.

17. The method of claim 2, further comprising:
receiving, by the computer based system, unsolicited customer application data for an unsolicited transaction account;
creating, by the computer based system, an underwriting decision on the customer application data for the unsolicited transaction account;
issuing, by the computer based system, the unsolicited transaction account; and
tracking, by the computer based system, profitability of the unsolicited transaction account, wherein the preprogrammed analytics for use in subsequent transaction account offerings are adjusted based upon the profitability tracking results.

18. The method of claim 1, further comprising:
reassessing, by the computer based system, the offering to the customer in response to receiving no response from the customer after a predetermined period of time;
producing, by the computer based system, a second customer list appended with second rank ordered, transaction account offerings and a second preferred delivery channel of the account offerings, wherein the producing uses preprogrammed analytics, data from the database, and user input, and wherein the second identified transaction account is the same type of transaction account as the transaction account previously offered to the customer, and wherein the second identified delivery channel is the same type of delivery channel as previously used to offer the transaction account to the customer, and
offering, by the computer based system and through the second identified delivery channel, the second transaction account offering to the customer.

19. A computer based system for providing financial product offerings comprising:
a processor; and
a memory in communication with the processor, the memory for storing a plurality of processing instructions for directing the processor to:
receive user input via a customizable interface which dynamically changes interrogation fields of the customizable interface based on the user input;
populate, based on the user input, fields for creating a database query for matching a selection of transaction account offerings to a population of customers;
receive data from the database in response to at least one of interactively building the query and executing the query;
produce a plurality of rank ordered results for comparison, wherein the producing uses preprogrammed analytics, data from the database and user input, and wherein the results include customer lists linked to a distinct transaction account offering and a preferred delivery channel of the distinct transaction account offering to a customer;
offer, through the preferred delivery channel, a transaction account from the rank ordered transaction account results to the customer; and
track the response of the customer to the offering, wherein the preprogrammed analytics are adjusted for use in subsequent transaction account offerings based upon the response tracking results.

20. A non-transitory computer-readable medium having stored thereon sequences of instruction, the sequences of instruction including instruction which when executed by a computer-based system for providing financial product offerings, causes the computer-based system to perform operations, comprising:
receiving, by the computer based system, user input via a customizable interface which dynamically changes interrogation fields of the customizable interface based on the user input;
populating, by the computer based system and based on the user input, fields for creating a database query for matching a selection of transaction account offerings to a population of customers;
receiving, by the computer based system, data from the database in response to at least one of interactively building the query and executing the query;
producing, by the computer based system, a plurality of rank ordered results for comparison, wherein the producing uses preprogrammed analytics, data from the database and user input, and wherein the results include customer lists linked to a distinct transaction account offering and a preferred delivery channel of the distinct transaction account offering to a customer;
offering, by the computer based system and through the preferred delivery channel, a transaction account from the rank ordered transaction account results to the customer; and
tracking, by the computer based system, the response of the customer to the offering, wherein the preprogrammed analytics are adjusted for use in subsequent transaction account offerings based upon the response tracking results.
